(19) United States
(12) Patent Application Publication
(10) Pub. No.: US 2011/0094290 A1
(43) Pub. Date: Apr. 28, 2011

(54) LOW POWER PRECONCENTRATOR FOR MICRO GAS ANALYSIS

(75) Inventors: Aaron Jay Knobloch, Niskayuna, NY (US); Glenn Scott Claydon, Wynantskill, NY (US); Wei-Cheng Tian, Clifton Park, NY (US); Zhiqiang Cao, Niskayuna, NY (US); Stacey Joy Kennerly, Albany, NY (US); Nannan Chen, Clifton Park, NY (US)

(73) Assignee: General Electric Company, Schenectady, NY (US)

(21) Appl. No.: 12/605,757

(22) Filed: Oct. 26, 2009

(51) Int. Cl. G01N 1/40; G01N 30/02; G01N 1/44

(52) U.S. Cl. 73/23.41; 73/863.11

(57) ABSTRACT

A low power preconcentrator for use in micro gas analysis, such as gas chromatography, and a system that employs the preconcentrator is disclosed. The preconcentrator includes a reservoir that comprises a heater membrane and elements coated at least partially with an adsorbent, and ports for receiving and discharging an analyte in communication with the reservoir. At least a portion of the reservoir (e.g., a cap) is made of a material having a thermal conductivity less than about 100 W/(m·K) and/or the heater membrane is made of a material that has a temperature difference less than about 75° C. when heated. The present invention has been described in terms of specific embodiment(s), and it is recognized that equivalents, alternatives, and modifications, aside from those expressly stated, are possible and within the scope of the appending claims.

This invention was made with Government support under contract number FA8650-04-1-7121 awarded by the Air Force. The Government has certain rights in the invention.

### BACKGROUND OF THE INVENTION

The present invention relates generally to gas chromatography and more particularly to improvements to the power demands of a mobile or microscale gas analysis preconcentrator and the gas analysis systems that employ them.

Typical gas chromatograph systems include a preconcentrator, a separator, a detector, and the like, all with the collective purpose to analyze gas mixtures. The preconcentrator receives an analyte (i.e., gas mixture) containing one or more chemicals and concentrates the analytes of interest. The analysts of interest are injected with a narrow pulse into a separator so that they may be separated from any interferents. A detector, or series of parallel detectors, then selectively detects the analytes of interest. Most gas chromatograph systems are large scale, table-top systems used in laboratory environments with high power requirements and slow response times.

In many applications, demands for high accuracy, rapid throughput detectors that are portable are growing in areas such as security, emissions monitoring, or healthcare. Microscale gas chromatographs are known to provide enhances speed and reduced size. One of the barriers to a portable chemical detector using a micro gas chromatograph is the power consumption of the system that could inhibit the throughput of the system. Improvements in the power consumption need to be balanced with maintaining the high level of performance that table-top gas chromatographs are known for.

Accordingly, there is an ongoing need for improving upon current gas analysis devices and systems.

### BRIEF DESCRIPTION

The present invention overcomes at least some of the aforementioned drawbacks by providing a preconcentrator and micro gas analysis system that has a reduced power requirement by employing a variety of techniques, while still maintaining the advantageous characteristics of speed, robustness, and performance.

Therefore, in accordance with one aspect of the invention, a preconcentrator for micro gas analysis includes a reservoir comprising: a heater membrane; and a plurality of elements coated with an adsorbent, wherein a portion of the reservoir comprises a material having a thermal conductivity less than about 100 W/(m·K); an analyte receiving port in fluidic communication with the reservoir; and an analyte discharging port in fluidic communication with the reservoir.

In accordance with another aspect of the invention, a preconcentrator for micro gas analysis includes a reservoir, wherein a portion of the reservoir comprises a heater membrane, wherein a temperature difference across the heater membrane upon heating is less than about 75° C.; an adsorbent in fluidic communication with an interior of the reservoir; an analyte receiving port in fluidic communication with the reservoir; and an analyte discharging port in fluidic communication with the reservoir.

In accordance with another aspect of the invention, a micro gas analysis system includes a preconcentrator comprising: a reservoir comprising: a heater membrane, wherein a temperature difference across the heater membrane upon heating is less than about 75° C.; an adsorbent in fluidic communication with an interior of the reservoir; wherein a portion of the reservoir comprises a material having a thermal conductivity less than about 100 W/(m·K); a separator in fluidic communication with the preconcentrator; and a detector in fluidic communication with the separator.

Various other features and advantages of the present invention will be made apparent from the following detailed description and the drawings.

### BRIEF DESCRIPTION OF THE DRAWINGS

The drawings illustrate one embodiment presently contemplated for carrying out the invention.

FIG. 1 is a schematic diagram of a micro gas analysis system incorporating aspects of the present invention.

FIG. 2 is an elevation cross-sectional view of a preconcentrator according to an embodiment of the present invention.

FIG. 3 is a plan sectional view of the preconcentrator of FIG. 2.

FIG. 4 is a top view of a heating membrane used in the preconcentrator of FIG. 2.

FIG. 5 is a bottom view of the heating membrane used in the preconcentrator of FIG. 2.

FIG. 6 is a diagram of a pulse width modulation heating signal control, in accordance with an embodiment of the present invention.

### DETAILED DESCRIPTION

Aspects of the present invention have been shown to offer advantages over previous systems for gas analysis by providing a lower power, high performance, preconcentrator for microscale gas chromatography. By preconcentrating the sample gas, lower detection limits can be achieved with better selectivity to interferents. The preconcentrator detailed within is able to reduce power consumption while maintaining a uniform temperature during use.

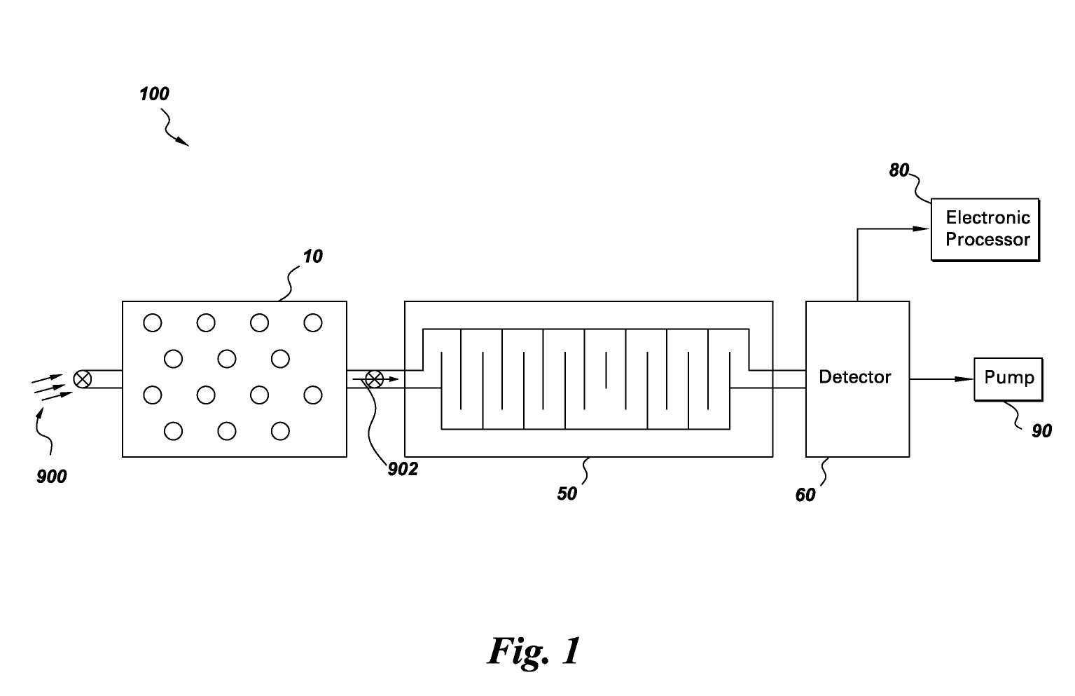

Referring to FIG. 1 a schematic diagram of an embodiment of a micro gas analysis system is depicted. The micro gas analysis system 100 comprises a preconcentrator 10, a separator 50, and at least one detector 60 all in fluid communication with each other to analyze a gas mixture 900. The system 100 may comprise an electronic processor 80 and a pump 90 in communication with the detector 60. The preconcentrator 10 receives gas mixture 900 and collects the analyte 902. The collected analyte 902 is injected as a narrow pulse into the separator 50. The separator 50, which typically includes a series of columns, separates the analyte 902 into the target chemicals, effectively removing any interferents. The detector 60, which may comprise a series of parallel detectors 60, selectively detects target chemicals.

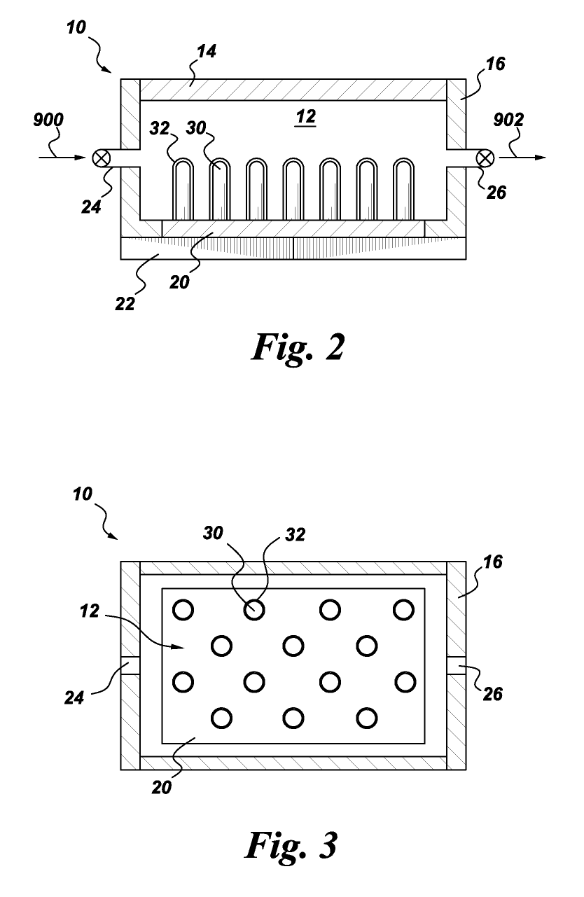

At least two goals are achieved by aspects of the present invention. A lower power consumption of the preconcentrator 10 is achieved, and accurate temperature control of the adsorbent used in the preconcentrator 10 is also achieved. Referring to FIGS. 2 and 3, an embodiment of a preconcentrator 10 is depicted. The preconcentrator 10 includes a reservoir or chamber 12 located within a structure having walls 16. In order to construct the preconcentrator 10 a portion of the walls 16 may be removable, thereby defining a cap 14. The preconcentrator 10 includes an inlet port 24 for receiving gas mixture 900 and an outlet port 26 for discharging the analyte 902 on to the separator 50 (FIG. 1). Valves may be used at the inlet port 24 and outlet port 26.

In this manner, gas mixture 900 is led into the reservoir 12 where it is selectively adsorbed by the adsorbent 32 at room temperature. Within the reservoir 12 is an adsorbent 32 which may be located on a plurality of elements 30. The elements may comprise pillars or other high surface area structures. Once a predetermined amount of the analyte 902 is adsorbed from the gas mixture 900, heat is applied to desorb the analyte 902 at a higher concentration. By applying the adequate amount of heat to the adsorbent 32, the analyte 902 is desorbed at a higher concentration and passed to the separator 50.

Heat to the reservoir 12 and adsorbent 32 therein is provided via a microhotplate, heating membrane, or other heating element 20.

In an aspect of the present invention, a portion of the reservoir 12 may be made of a material that has lower thermal conductivity properties, thereby lowering heat loss out of the preconcentrator 10. This ultimately results in a reduction in power consumption requirements for the preconcentrator 10 and system 100 (FIG. 1). For example, a portion of the reservoir 12 may have a thermal conductivity that is less than about 100 W/(m·K). In another embodiment, the thermal conductivity of the portion of the reservoir 12 is less than about 10 W/(m·K). The portion of the reservoir 12 exhibiting the improved thermal conductivity may be the cap 14. The cap 14 may be constructed of various ceramics, quartz, polymers, and combinations thereof. In an embodiment, the cap 14 may comprise low temperature co-fired ceramic (LTCC).

In another aspect of the present invention a more uniform thermal gradient of the heating membrane 20 is obtained. In typical use the heating membrane 20 is heated to a sufficiently high enough temperature so that the analyte 902 is desorbed by the activated adsorbent 32, yet not beyond temperature(s) that may destroy the adsorbent 32. In an embodiment, the heating membrane 20 is heated to between about 300° C. and about 375° C. The construction of the heating membrane 20 is such that the temperature difference across the entire heating membrane 20 is less than about 25° C.

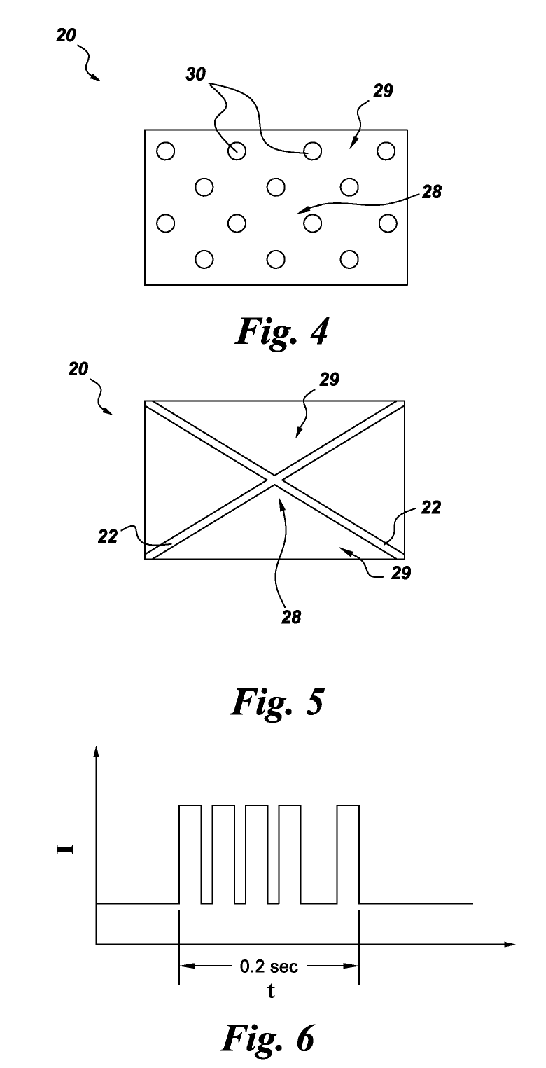

Referring to FIGS. 4 and 5 an embodiment of a heating membrane 20 is depicted. Extending from an upper surface of the heating membrane 20 are a plurality of elements 30 for holding the adsorbent 32 (see e.g., FIG. 2). It has been discovered that during heating of the heating membrane 20, that in general a middle portion 28 of the heating membrane 20 gets hotter than the outer portion 29 of the heating membrane 20. By shunting the middle portion 28 of the heating membrane 20 to the outer portion 29 of the heating membrane 20 an improvement in the temperature gradient across the heating membrane 20 is obtained. Various ribs 22 may be constructed along the bottom surface of the heating membrane 20. The ribs 22 may be in a X-shaped (FIG. 5) or cross-shaped configuration in order to aid in dissipating heat away from the middle portion 28 of the heating membrane 20 towards the outer portion 29 of the heating membrane 20. In this manner, the heating membrane 20 has a reduced thermal gradient and is structurally stiffer with reduction of deflection in the heating membrane 20.

It should be apparent to one in the art that other arrangements and configurations of shunting the heating membrane 20 are part and parcel of aspects of the present invention. Other attributes may be used to shunt the heating membrane 20. For example, instead of ribbing 22, the thickness of the heating membrane 20 may vary in depth between the middle portion 28 of the heating membrane 20 to the outer portion 29 of the heating membrane 20. For example, the middle portion 28 may be thicker than the outer portion 29. Similarly, the ribbing 22 may extend only partially to the outer portion 29. The ribbing need not be uniform and symmetrical. The ribbing also may be on the upper portion of the heating membrane 20.

In another aspect of the present invention, the heating membrane 20 receives a pulse width modulation from a current source. As FIG. 6 shows, pulses of current over time can be supplied to the heating membrane 20 (FIGS. 4, 5). The pulsed configuration results in energy savings and less loss of heat, while still providing adequate time-to-temperature for heating the membrane 20. As shown, an embodiment includes applying multiple (e.g., five) pulses of current over a 0.2 second duration.

It should be apparent to one in the art that other arrangements and configurations of heating the heating membrane 20 are part and parcel of aspects of the present invention. Other quantities of current pulses, durations of current pulses, and/or rates of current pulses may be employed under the present invention. For example, ten (10) pulses of a lesser current could be applied over a 0.3 second duration. Similarly, the magnitude of the current pulses may be of a different magnitude or they may vary over time.

While the embodiments illustrated and described herein may be used with a micro gas preconcentrator 10 that is part of a micro gas analysis system 100, other systems may employ aspects of the present invention without departing from the scope of the invention. For example, the preconcentrator may be part of a stationary (i.e., non-portable) gas analysis system, and the like.

Therefore, according to one embodiment of the present invention, a preconcentrator for micro gas analysis includes a reservoir comprising: a heater membrane; and a plurality of elements coated with an adsorbent, wherein a portion of the reservoir comprises a material having a thermal conductivity less than about 100 W/(m·K); an analyte receiving port in fluidic communication with the reservoir; and an analyte discharging port in fluidic communication with the reservoir.

According to another embodiment of the present invention, a micro gas analyzer system includes a preconcentrator comprising: a reservoir comprising: a heater membrane, wherein a temperature difference across the heater membrane upon heating is less than about 75° C.; an adsorbent in fluidic communication with an interior of the reservoir; wherein a portion of the reservoir comprises a material having a thermal conductivity less than about 100 W/(m·K); a separator in fluidic communication with the preconcentrator; and a detector in fluidic communication with the separator.

The present invention has been described in terms of the preferred embodiment, and it is recognized that equivalents, alternatives, and modifications, aside from those expressly stated, are possible and within the scope of the appending claims.

What is claimed is:

1. A preconcentrator for micro gas analysis comprising:
a reservoir comprising:
a heater membrane; and
a plurality of elements coated with an adsorbent, wherein a portion of the reservoir comprises a material having a thermal conductivity less than about 100 W/(m·K);
an analyte receiving port in fluidic communication with the reservoir; and
an analyte discharging port in fluidic communication with the reservoir.

2. The preconcentrator of claim 1, wherein the portion comprises a cap.

3. The preconcentrator of claim 1, wherein the portion is made of a material comprising ceramics, glass, quartz, polymers, and combinations thereof.

4. The preconcentrator of claim 1, wherein the portion is made of a material comprising a low temperature co-fired ceramic.

5. The preconcentrator of claim 1, wherein the adsorbent comprises metal organic framework.

6. The preconcentrator of claim 1, wherein the thermal conductivity is less than about 10 W/(m·K).

7. The preconcentrator of claim 1, further comprising a current source in electric communication with the heater membrane, wherein the current source is configured to send a pulse width modulation current to the heater membrane.

8. A preconcentrator for micro gas analysis comprising:
a reservoir, wherein a portion of the reservoir comprises a heater membrane, wherein a temperature difference across the heater membrane upon heating is less than about 75° C.;
an adsorbent in fluidic communication with an interior of the reservoir;
an analyte receiving port in fluidic communication with the reservoir; and
an analyte discharging port in fluidic communication with the reservoir.

9. The preconcentrator of claim 8, wherein the temperature difference is less than about 25° C.

10. The preconcentrator of claim 8, wherein a cap of the reservoir is made of a material comprising a low temperature co-fired ceramic.

11. The preconcentrator of claim 8, wherein a temperature of the heater membrane upon heating is between about 300° C. and about 375° C.

12. The preconcentrator of claim 8, wherein a bottom portion of the heater membrane comprises at least one rib element extending from a center region of the bottom portion to a peripheral region of the bottom portion.

13. The preconcentrator of claim 12, wherein the at least one rib element comprises one of a X-shaped rib construct and a cross-shaped rib construct.

14. The preconcentrator of claim 8, further comprising a current source in electric communication with the heater membrane, wherein the current source is configured to send a pulse width modulation current to the heater membrane.

15. A micro gas analysis system comprising:
a preconcentrator comprising:
a reservoir comprising:
a heater membrane, wherein a temperature difference across the heater membrane upon heating is less than about 75° C.;
an adsorbent in fluidic communication with an interior of the reservoir;
wherein a portion of the reservoir comprises a material having a thermal conductivity less than about 100 W/(m·K);
a separator in fluidic communication with the preconcentrator; and
a detector in fluidic communication with the separator.

16. The system of claim 15, wherein the system is substantially portable.

17. The system of claim 15, wherein the preconcentrator and the separator draw less than about 1 Joule during an analysis.

18. The system of claim 15, wherein the preconcentrator draws less than about 0.5 Joule during an analysis.
